(19) United States
(12) Patent Application Publication
(10) Pub. No.: US 2016/0266080 A1
(43) Pub. Date: Sep. 15, 2016

(54) FORMALDEHYDE TEST REAGENT

(71) Applicant: DOW GLOBAL TECHNOLOGIES LLC, Midland, MI (US)

(72) Inventors: Emmanuel Appiah-Amponsah, Royersford, PA (US); Emre Discekici, Buffalo Grove, IL (US)

(73) Assignee: Dow Global Technologies LLC, Midland, MI (US)

(21) Appl. No.: 15/031,850

(22) PCT Filed: Nov. 5, 2014
(86) PCT No.: PCT/US14/64056

§ 371 Date: Apr. 25, 2016

Related U.S. Application Data
(60) Provisional application No. 61/903,607, filed on Nov. 13, 2013.

(51) Int. Cl. G01N 31/22

(52) U.S. Cl. CPC G01N 31/22

(57) ABSTRACT

An aqueous test reagent for detection of formaldehyde. The reagent comprises acetylacetone; ammonia, a C₁-C₄ primary amine or salts thereof; and a C₄-C₈ aliphatic organic dicarboxylic or tricarboxylic acid.

### BACKGROUND

This invention relates generally to a formaldehyde test reagent having improved stability.

Nash reagent is a widely used reagent consisting of a solution containing ammonium acetate, acetyl acetone and acetic acid. The reagent is used for the specific detection of formaldehyde in different matrices. See Nash, T. (1952). Nature, Lond., 170, 976. While this reagent has shown utility for the sensitive detection of formaldehyde, its use in a test kit format is often hindered by the short shelf life on the order of approximately two weeks.

Anything that can be done to enhance the storage stability of the Nash reagent without adversely affecting its ability to detect formaldehyde would be advantageous.

### STATEMENT OF INVENTION

The present invention is directed to an aqueous test reagent; said reagent comprising acetylacetone; ammonia, a C₁-C₄ primary amine or salts thereof; and a C₄-C₈ aliphatic organic dicarboxylic or tricarboxylic acid.

### DETAILED DESCRIPTION

All percentages are weight percentages (“wt %”) and temperatures in ° C., unless otherwise indicated. Experiments were performed at room temperature (20-25° C.), unless otherwise indicated. An “organic” acid is one not containing more than trace levels of a metal, preferably one having only carbon, hydrogen and oxygen atoms.

The C₄-C₈ aliphatic organic dicarboxylic or tricarboxylic acid has a total of four to eight carbon atoms, including carboxyl carbon atoms. Preferably, the C₄-C₈ aliphatic organic dicarboxylic or tricarboxylic acid has at least one hydroxyl group, preferably one or two, preferably one. Preferably, the acid is a C₄-C₆ aliphatic organic dicarboxylic or tricarboxylic acid, preferably a C₅-C₆ aliphatic organic dicarboxylic or tricarboxylic acid. Preferably, the acid is a tricarboxylic acid, preferably a C₆ tricarboxylic acid. Preferred aliphatic organic dicarboxylic or tricarboxylic acids include citric acid, isocitric acid, tartaric acid, meso-tartaric acid, malic acid, succinic acid, 2-hydroxymalonic acid and malonic acid. Citric acid is especially preferred. Preferably, the aqueous test reagent comprises no more than 0.1 wt % of any acid other than a C₄-C₈ aliphatic organic dicarboxylic or tricarboxylic acid, preferably no more than 0.05 wt %, preferably no more than 0.02 wt %, preferably no more than 0.01 wt %. Preferably, the aqueous test reagent comprises no more than 0.1 wt % of acetic acid, preferably no more than 0.05 wt %, preferably no more than 0.02 wt %, preferably no more than 0.01 wt %.

Preferably, the ammonia or C₁-C₄ primary amine or salts thereof is limited to ammonia or a salt thereof. Preferred salts include acetate, phosphates (including hydrogen phosphate and dihydrogen phosphate), carbonate and bicarbonate; preferably acetate and phosphate. Especially preferred ammonium salts include ammonium phosphate and ammonium acetate, preferably ammonium acetate. Preferably, the ammonia or C₁-C₄ primary amine or salts thereof is present in the reagent in an amount from 0.5 to 5 moles/liter, preferably from 1 to 3 moles/liter, preferably from 1.5 to 2.5 moles/liter, concentrations based on the salt.

Preferably, the aqueous test reagent comprises acetylacetone in a concentration from 0.005 to 0.05 moles/liter, preferably from 0.01 to 0.04 moles/liter, preferably from 0.02 to 0.03 moles/liter. Preferably, the aqueous formaldehyde test reagent comprises a C₄-C₁₀ aliphatic organic dicarboxylic or tricarboxylic acid in a concentration from 0.01 to 0.1 moles/liter, preferably from 0.02 to 0.08 moles/liter, preferably from 0.04 to 0.06 moles/liter.

Preferably, the aqueous test reagent comprises from 75 to 90 wt % water, preferably from 80 to 88 wt % water, preferably from 82 to 86 wt % water.

Preferably, the pH of the aqueous test reagent is from 2 to 7.5, preferably from 4 to 7, preferably from 5 to 6.5, preferably from 5.4 to 6.2.

The present invention is further directed to a method for detecting formaldehyde in which a sample to be tested for formaldehyde is combined with the reagent and an absorbance reading is taken to detect an absorption at approximately 412 nm. Preferably, the sample and the reagent are contacted at room temperature, preferably for at least one minute, preferably for at least three minutes. Times over ten minutes are not necessary.

### EXAMPLES

### Preparation of Nash Reagent Variations

| | Acid Variations** | | | | |
|---|---|---|---|---|---|
| | | | Hydrochloric | | |
| Compounds | Citric | Formic | (37%) | Sulfuric | Acetic |
| Ammonium | 15.0025 | 15.0025 | 15.0027 | 15.0053 | 15 |
| Acetate (g) | | | | | |
| Acid | 0.97 g | 0.23 mL | 0.49 mL | 0.49 mL | 0.3 mL |
| Acetyl | 0.2 | 0.2 | 0.2 | 0.2 | 0.2 |
| Acetone (mL) | | | | | |

**Variations were diluted to 100-mL with DDI Millipore water

### Sample Preparation

Samples of pure glutaraldehyde intentionally spiked with approximately 0.50%, 1.0%, and 10.0% formaldehyde were prepared in order to replicate adulterated samples. The samples were then subsequently diluted 1:2000 times in DDI water before proceeding with testing procedure.

### Formaldehyde Detection Test Procedure (Quantitative)

The test reaction was performed by adding 4.0 mL of diluted sample to 2.0 mL of Nash reagent. After allowing the reaction to take place for 6-minutes, an absorbance reading is taken, followed by another absorbance reading immediately after the first reading is displayed. Both readings are recorded and averaged. The samples were tested over a six-week period. Absorbance readings at 420 nm for the samples were taken on a HACH colorimeter and are tabulated below.

TABLE 1A
Table showing absorbance readings at Week 0 of each variation as a
blank and of readings when reacted with samples for 6 minutes

| | Blank | | | 0.5% FA | | | 10% FA | | |
|---|---|---|---|---|---|---|---|---|---|
| Acid | ABS 1 | ABS 2 | Avg. | ABS 1 | ABS 2 | Avg. | ABS 1 | ABS 2 | Avg. |
| Citric | 0.023 | 0.022 | 0.0225 | 0.188 | 0.193 | 0.1905 | 2.787 | 2.833 | 2.810 |
| Formic | 0.029 | 0.03 | 0.0295 | 0.147 | 0.151 | 0.1490 | 1.966 | 2.009 | 1.988 |
| HCl | 0.028 | 0.029 | 0.0285 | 0.179 | 0.184 | 0.1815 | 2.581 | 2.633 | 2.607 |
| Sulfuric | 0.027 | 0.028 | 0.0275 | 0.194 | 0.198 | 0.1960 | 2.712 | 2.764 | 2.738 |
| Acetic | 0.027 | 0.028 | 0.0275 | 0.154 | 0.159 | 0.1565 | 2.339 | 2.429 | 2.384 |

TABLE 1B
Table showing absorbance readings at Week 6 (25° C. ) of each variation
as a blank and of readings when reacted with samples for 6 minutes

| | Blank | | | 0.5% FA | | | 10% FA | | |
|---|---|---|---|---|---|---|---|---|---|
| Acid | ABS 1 | ABS 2 | Avg. | ABS 1 | ABS 2 | Avg. | ABS 1 | ABS 2 | Avg. |
| Citric | 0.043 | 0.043 | 0.043 | 0.158 | 0.162 | 0.16 | 1.961 | 2.002 | 1.982 |
| Formic | 0.097 | 0.098 | 0.098 | 0.168 | 0.172 | 0.17 | 1.913 | 1.956 | 1.935 |
| HCl | 0.129 | 0.13 | 0.13 | 0.153 | 0.157 | 0.155 | 1.802 | 1.844 | 1.823 |
| Sulfuric | 0.11 | 0.111 | 0.111 | 0.153 | 0.157 | 0.155 | 1.9 | 1.939 | 1.920 |
| Acetic | 0.122 | 0.123 | 0.123 | 0.156 | 0.162 | 0.159 | 1.939 | 1.983 | 1.961 |

TABLE 1C
Table showing absorbance readings at Week 6 (30° C. ) of each variation
as a blank and of readings when reacted with samples for 6 minutes

| | Blank | | | 0.5% FA | | | 10% FA | | |
|---|---|---|---|---|---|---|---|---|---|
| Acid | ABS 1 | ABS 2 | Avg. | ABS 1 | ABS 2 | Avg. | ABS 1 | ABS 2 | Avg. |
| Citric | 0.041 | 0.042 | 0.042 | 0.122 | 0.126 | 0.12 | 1.536 | 1.57 | 1.553 |
| Formic | 0.143 | 0.143 | 0.143 | 0.123 | 0.126 | 0.12 | 1.267 | 1.298 | 1.283 |
| HCl | 0.173 | 0.175 | 0.174 | 0.13 | 0.133 | 0.13 | 1.121 | 1.148 | 1.135 |
| Sulfuric | 0.135 | 0.137 | 0.136 | 0.134 | 0.137 | 0.14 | 1.349 | 1.376 | 1.363 |
| Acetic | 0.204 | 0.205 | 0.205 | 0.145 | 0.147 | 0.15 | 1.268 | 1.296 | 1.282 |

The measured absorbance values provide striking evidence supporting the enhanced stability and equal if not greater efficacy of the citric acid variation when compared to acetic acid and the other acids.

Of the 5 different acids tested in this study, the acetic acid variation showed the greatest instability at both 25° C. and 30° C., as its increase in absorbance over time was the most rapid. The formic and hydrochloric acid variations, though not as drastic as acetic acid, also indicated relatively poor stability in comparison to citric acid. The sulfuric acid variation, though slightly more stable than the aforementioned variations, finished a distant second. However, because of its high corrosiveness, sulfuric acid is not a viable replacement for acetic acid.

The citric acid variation was determined to be the most stable amongst the different variations at both 25° C. and 30° C., with the latter illustrating an overwhelming difference in stability. At a temperature of 25° C., the stability, directly related to the intensity of yellowing over time, in the citric acid variation is on the order of 5 times more stable than acetic acid, and at 30° C. an astounding 12 times more stable based on calculated linear regression slope over the entire study. By observing the same correlation across two different storage conditions, we can conclude that the acetic acid variation is considerably less stable than the citric acid variation and that its instability is further accelerated with elevated temperatures.

Furthermore, we provide convincing evidence highlighting the pitfalls of using traditional Nash reagent. It was discovered that after 3 weeks at 30° C., the blank absorbance value nearly overlaps when reacted with the value from the sample adulterated with 0.50% formaldehyde. This confirms growing interference of the reagent itself when used for formaldehyde detection. This is a potentially major issue that could be avoided with the use of the citric acid variation, as there is no possibility of overlapping blank and low-level formaldehyde containing samples.

It is also worth noting that the greater stability found in the citric acid variation seems to correspond to higher absorbance values, and therefore greater efficacy, when reacted with samples adulterated with concentrations of formaldehyde near 0.50%.

TABLE 2A
Table of traditional Nash reagent stored at 30° C. showing
nearly overlapping values of blank and 0.5% adulterated
sample at week 3.

ABS @
420 nm

| Week | Blank | 0.5% FA |
|---|---|---|
| 0 | 0.0275 | 0.1565 |
| 1 | 0.0615 | 0.171 |
| 2 | 0.0975 | 0.205 |
| 3 | 0.1425 | 0.154 |
| 4 | 0.1595 | 0.155 |
| 6 | 0.2045 | 0.146 |

TABLE 2B
Table of Citric acid variation Nash reagent stored at 30° C. showing
no possibility of overlapping values even after 6-weeks.

ABS @
420 nm

| Week | Blank | 0.5% FA |
|---|---|---|
| 0 | 0.0345 | 0.1905 |
| 1 | 0.0415 | 0.172 |
| 2 | 0.039 | 0.209 |
| 3 | 0.0405 | 0.151 |
| 4 | 0.0385 | 0.14 |
| 6 | 0.0415 | 0.124 |

pH values for Nash reagents made with citric, sulfuric and acetic acids are tabulated below:

| pH @ 25° C. | NASH Variation | | |
|---|---|---|---|
| Days | Citric | Sulfuric | Acetic |
| 0 | 5.889 | 5.77 | 6.303 |
| 7 | 5.895 | 5.772 | 6.306 |
| 14 | 5.908 | 5.798 | 6.305 |
| 23 | 5.921 | 5.762 | 6.263 |
| 30 | 5.925 | 5.799 | 6.306 |
| 0 | 5.889 | 5.77 | 6.303 |
| 7 | 5.874 | 5.759 | 6.264 |
| 14 | 5.877 | 5.796 | 6.298 |
| 23 | 5.956 | 5.791 | 6.316 |
| 30 | 5.912 | 5.781 | 6.28 |

1. An aqueous test reagent; said reagent comprising acetylacetone; ammonia, a C₁-C₄ primary amine or salts thereof; and a C₄-C₈ aliphatic organic dicarboxylic or tricarboxylic acid.

2. The reagent of claim 1 in which said ammonia, a C₁-C₄ primary amine or salts thereof is limited to ammonia or a salt thereof.

3. The reagent of claim 2 in which the C₄-C₈ aliphatic organic dicarboxylic or tricarboxylic acid is a C₄-C₆ aliphatic organic dicarboxylic or tricarboxylic acid having one or two hydroxyl groups.

4. The reagent of claim 3 in which the reagent comprises from 0.5 to 5 moles/liter of ammonia or a salt thereof, from 0.01 to 0.1 moles/liter of the organic dicarboxylic or tricarboxylic acid and from 0.005 to 0.05 moles/liter acetylacetone; and in which pH of the reagent is from 4 to 7.

5. The reagent of claim 4 in which the organic dicarboxylic or tricarboxylic acid is selected from the group consisting of citric acid, isocitric acid, tartaric acid, meso-tartaric acid and malic acid.

6. The reagent of claim 1 in which the C₄-C₈ aliphatic organic dicarboxylic or tricarboxylic acid is selected from the group consisting of citric acid, isocitric acid, tartaric acid, meso-tartaric acid, malic acid, succinic acid, 2-hydroxymalonic acid and malonic acid.

7. The reagent of claim 6 in which said ammonia, a C₁-C₄ primary amine or salts thereof is limited to ammonia or a salt thereof.

8. The reagent of claim 7 in which the reagent comprises from 0.5 to 5 moles/liter of ammonia or a salt thereof, from 0.01 to 0.1 moles/liter of the organic dicarboxylic or tricarboxylic acid and from 0.005 to 0.05 moles/liter acetylacetone; and in which pH of the reagent is from 4 to 7.

9. The reagent of claim 8 in which the C₄-C₈ aliphatic organic dicarboxylic or tricarboxylic acid is citric acid.

10. The reagent of claim 9 in which said ammonia or a salt thereof is ammonium acetate.
